(19) United States
(12) Patent Application Publication
(10) Pub. No.: US 2007/0250597 A1
(43) Pub. Date: Oct. 25, 2007

(54) Controller for modifying and supplementing program playback based on wirelessly transmitted data content and metadata

(75) Inventors: Benjamin I. Resner, Roxbury, MA (US); Robert Dredge, Somerville, MA (US); Pritesh V. Gandhi, Boston, MA (US); David L. Rose, Cambridge, MA (US)

Correspondence Address: CHARLES G. CALL, 215 W. HURON ST APT 2, CHICAGO, IL, 60610-3331, US

(73) Assignee: Ambient Devices, Inc., Cambridge, MA (US)

(21) Appl. No.: 11/726,000

(22) Filed: Mar. 20, 2007

Related U.S. Application Data
(63) Continuation-in-part of application No. 10/247,780, filed on Sep. 19, 2002.
(63) Continuation-in-part of application No. 11/149,929, filed on Jun. 10, 2005.
(60) Provisional application No. 60/783,902, filed on Mar. 20, 2006.
(60) Provisional application No. 60/578,629, filed on Jun. 10, 2004.

(51) Int. Cl. G06F 15/16; G09G 5/00

(52) U.S. Cl. 709/218; 715/864

(57) ABSTRACT

A wireless data processing module for use with a portable audio or video player. The module connects to the expansion port connector on an existing player which provides an interface port for exchanging data and control signals between the auxiliary module and the player. The module includes a radio receiver for receiving data signals from a wireless data transmission network that are temporarily stored in a cache memory. A controller responsive to operating commands accepted from a user interoperates with the player to selectively play program content that is persistently stored by the player and to render selected data signals in the cache memory in an audible or visual form perceptible to said user, thereby supplementing the content available to the user with recently produced content provided via the wireless network.

### CROSS REFERENCE TO RELATED APPLICATIONS

This application is a non-provisional of, and claims the benefit of the filing date of, U.S. Provisional Patent Application Ser. No. 60/783,902 filed on Mar. 20, 2006.

This application is also a continuation in part of, and claims the benefit of the filing date of, U.S. patent application Ser. No. 10/247,780 filed Sep. 19, 2002 and published as U.S. Patent Application Publication 2003/0076369 on Apr. 24, 2003. application Ser. No. 10/247,780 was a non-provisional of the following Provisional Applications: Ser. No. 60/323,493, filed Sep. 19, 2001, Ser. No. 60/358,272, filed Feb. 20, 2002, and Ser. No. 60/398,648 filed Jul. 25, 2002.

This application is also a continuation in part of, and claims the benefit of the filing date of, U.S. patent application Ser. No. 11/149,929 filed on Jun. 10, 2005 and published as U.S. Patent Application Publication 2007/0035661 on Feb. 15, 2007 which is a non-provisional of U.S. Patent Application Ser. No. 60/578,629 filed Jun. 10, 2004 and is a continuation in part of the above-noted U.S. patent application Ser. No. 10/247,780.

The disclosures of the above-identified U.S. Application Publications are incorporated herein by reference.

### FIELD OF THE INVENTION

This invention relates to audio and video playback systems.

### BACKGROUND OF THE INVENTION

The present invention can be used to advantage to combine the functions and benefits provided by two different existing technologies: audio and video program storage and playback devices and a nationwide datacasting network such as the Ambient Information Network operated by Ambient Devices, Inc. of Cambridge, Mass. Before describing the present invention, some of the leading characteristics of these program storage and playback devices and of these commercial datacasting networks will be briefly summarized.

Audio Storage and Playback Devices

Audio players such as the hand-held iPod® player marketed by Apple, Inc. of Cupertino, Calif. are now in widespread use. These audio players store music and other audio programming in compressed form such as the widely used MP3 format that allows a much greater amount of audio content to be stored on a device than do uncompressed formats such as WAV or AIFF files. These audio players store media content, including audio, video and image files, in inexpensive and physically compact persistent storage devices, such as hard drives and high-capacity flash memories. These compact storage devices have significant advantages over older media such as vinyl records, cassette tapes, and CDs because they are physically smaller, have greater storage capacity, are often much more rugged, and can be written to and read from many times.

Audio and video players may typically be connected to a personal computer via a USB or Firewire connection and can have media files stored on the computer transferred to the device at a very high rate of speed. Users also typically use the computer as a conduit between the player and an online media retail store where the user can purchase new audio and video files for the player. Audio and video players are often incorporated into cell phones or other devices such as PDAs (personal digital assistants) which incorporate wireless data transmission capabilities that permit media content to be downloaded wirelessly from online stores or other sources.

Audio and video players are now most commonly portable battery-powered handheld units, but they may also be found on a desktop or in a rack or shelf-mounted home installation, as well as in car dashboards. Such players typically also include a LCD (liquid crystal display) that shows information such as song title, track, genre, and length, and permits the user to make selections and enter preference data using a menu system of displayed prompts. Many MP3 players also show non-audio related information such as the current time or amount of charge left in the battery. Some players, such as the Apple iPod®, incorporate full-color backlit LCD screens capable of playing back video (such as MPEG) or showing albums of full-color photographs. Less expensive audio players incorporate only monochrome text LCD displays, or no screen at all.

An increasingly common feature of audio and video players is an expansion port that allows users to connect accessory devices such as chargers, remote controls, amplified speakers or a microphone. These expansion ports also typically allow control of device functions such as “play”, “pause”, “fast forward” for operation by an external controller such as an in-dash car music system or handheld infrared remote control unit. These expansion ports can also make available information about the state of the player. The exact functionality exposed by an expansion dock depends on the particular model of the audio player. Other possible operations and parameters of audio players that can be controlled via an expansion dock or port include:
Data displayed on the screen.
Playlist entries, as well as ability to control the playlist entries.
Volume control
Power on/off
Space available on device
Current selection being played
Length of current selection being played
Amount of time remaining in current selection being played
Type of encoding for current selection

The Ambient Information Network

Ambient Devices, Inc. of Cambridge, Mass., operates a nationwide wireless network optimized for sending content over a long-range bandwidth-constrained, metered-use network, and markets devices that receive and display information specially encoded for transmission via this network. As explained in the description that follows, the Ambient Information Network, or another wireless transmission system capable of transmitting data bearing messages to remotely located radio receivers, may be used to supplement the content presented by a playback device and to control its operation in ways that the user specifies and controls. Wireless data transmission networks that provide low-cost, low-bandwidth transmission pathways that are suitable for use with the invention described below employ various technologies, including GSM, FLEX, reFLEX, control channel telemetry, FM or TV subcarrier, digital audio, satellite radio, WiFi, WiMax, and Cellular Digital Packet Data (CDPD) systems. Each of these networks provides a communication pathway for the transmission of data bearing messages that conform to a standard data format normally employed by the given network. In the preferred embodiments, the same data bearing message is typically simulcast via the wireless network to many different display devices which may render the received data in the same or different ways.

Typical displays used to display data values transmitted via such a datacasting network may employ a very simple glanceable format, translating the received data values to convey information by a shift in color, a change in the position of a gauge hand, a descriptive graphical icon, or a short text fragment. These devices can display meaningful information with as little as one or two bytes of new content, making them extremely efficient in limited bandwidth and/or cost sensitive environments. The Ambient Information Network and a variety of rendering devices are described in the above-noted U.S. Patent Application Publication Nos. 2003/0076369 and 2007/0035661.

### SUMMARY OF THE INVENTION

The preferred embodiment of the present invention takes the form of an program player that can receive and store wirelessly transmitted content that is rendered by the player in a variety of user-configurable ways that can include both audio and video rendering as well as modifications to the manner in which such audio and/or visual rendering occurs, such as varying the selection and sequence of program content and the manner in which the wirelessly transmitted supplemental content is integrated with content that is persistently stored by the player.

The preferred embodiment may be implemented by a wireless data processing module for use with an existing audio or video player, or may be built into the player as originally manufactured. When implemented as an auxiliary module, the existing player's interface port is used to exchange data and control signals with the auxiliary module. The module contains a radio receiver for receiving data signals from a wireless data transmission network which is preferably implemented using an existing datacasting facility selected from the group comprising GSM, FLEX, reFLEX, control channel telemetry, FM or TV subcarrier, digital audio, satellite radio, WiFi, WiMax, and Cellular Digital Packet Data (CDPD) networks. A cache memory stores selected data signals, and a controller responsive to operating commands accepted from a user selectively plays program content segments persistently stored by the player and also renders selected data signals stored in the cache memory in a form perceptible to the user.

The wireless data processing module can render selected data signals in the cache memory as a visual presentation on the player's display screen. The visual display may include displayed text derived from selected data signals or one or more graphical symbols which are representative of the values represented by selected data signals.

The wireless data processing module may also renders selected data signals in the cache memory as a audio presentation delivered to the player's audio output port. This audio presentation may be produced in substantially real time immediately after the reception of the selected data signals by the radio receiver, or may be delivered to the output port in response to operating commands accepted from the user, or may be inserted between the playing of successive program content segments persistently stored by the audio player. A mixer may be used to combine selected portions of the stored program content segments with selected portions of the audio presentation derived from the datacast data for simultaneous delivery to the audio output port. A speech synthesizer may be used for rendering selected data signals as a spoken audio presentation.

The system preferably permits the user to independently control the play of the program content segments and the rendering of selected data signals. Preference indications supplied by or on behalf of the user may be used to select specific datacast signals being received from the network or previously stored in the cache memory. These and other preference values may be supplied by or on behalf of the user by employing a web browser to submit the preference indications to a web server to control the content of the data signals transmitted to the radio receiver via the wireless data transmission network. Alternatively, preference values may be supplied by the user using the controls on the player device or an external module; for example, by selecting options presented by a menu-driven prompting system.

The sequential order in which the program content segments persistently stored on the player are selectively played may be varied response to selected ones of the data signals, and the data signals may include a playlist which selects and orders the presentation of stored programs and supplemental presentations defined by the datacast information.

### BRIEF DESCRIPTION OF THE DRAWINGS

In the detailed description which follows, frequent reference will be made to the attached drawings, in which:

FIG. 1 is an illustration of a conventional audio playback device used in combination with an external audio datacasting receiver and control module that implements the invention;

FIG. 2 is illustration of visual display of both playlist content and datacast news;

FIG. 3 illustrates a second visual display containing a graphical display of selected stock prices and playlist content;

FIG. 4 is a block diagram illustrating the principle hardware components used in a preferred embodiment of the invention;

FIG. 5 is a chart illustrating the timing of a representative playback session and the wireless transmission of data used to supplement and control that playback session;

FIG. 6 is a schematic overview of the Ambient Information Network which may be employed as a datacasting facility operating as a content source for implementations of the present invention as well as other devices; and

FIG. 7 is a further illustration of the Ambient Information Network.

### DETAILED DESCRIPTION

An audio player accessory module implementation of the invention

In the description that follows, a specific illustrative implementation of the invention will be described, and will be followed by a discussion of modifications and alternative arrangements contemplated by the invention.

FIG. 1 illustrates how the invention can be implemented by combining an existing conventional audio player 101, such as a iPod® player manufactured by Apple, Inc., 1 Infinite Loop, Cupertino, Calif. 95014, and an auxiliary module 102 which can be attached to and used to control the operation of the player 101. The auxiliary module 102 includes a small display screen 103 as well a set of light emitting diodes (LEDs) 104 that can be used to indicating such things such as a low battery condition or the availability of new content to the user. It should be understood that the functionality provided by the module 102 may be integrated into a player at time of its manufacture; for example, the components of the module 102 may be implemented as a chipset or the like and included within the housing of the player as originally manufactured.

The auxiliary module 102 connects to the audio player 101 via a docking connector (not shown) provided by the player manufacturer for connecting to power and data sources. For example, an Apple iPod® player can be charged, connected to a PC via USB or Firewire data port, connected to an external audio system, such as a stereo amplifier, via line-out or connected to a serial device and controlled via the Apple Accessory Protocol. The Apple iPod® player connector includes 32 pins having the functions listed in Table 1, below:

| | |
|---|---|
| 1 | Ground (−) |
| 2 | Line Out - Common Ground (−) |
| 3 | Line Out - R (+) |
| 4 | Line Out - L (+) |
| 5 | Line In - R (+) |
| 6 | Line In - L (+) |
| 7 | RFU |
| 8 | Video Out - Composite Video |
| 9 | S-Video Chrominance |
| 10 | S-Video Luminance |
| 11 | Serial GND |
| 12 | Serial TxD |
| 13 | Serial RxD |
| 14 | RFU |
| 15 | Ground (−) |
| 16 | USB GND (−) |
| 17 | RFU |
| 18 | 3.3 V Power (+) |
| 19 | Firewire Power 12 VDC (+) |
| 20 | Firewire Power 12 VDC (+)³ |
| 21 | Accessory Indicator |
| 22 | FireWire Data TPA (−) |
| 23 | USB Power 5 VDC (+) |
| 24 | FireWire Data TPA (+) |
| 25 | USB Data (−) |
| 26 | FireWire Data TPB (−) |
| 27 | USB Data (+) |
| 28 | FireWire Data TPB (+) |
| 29 | FireWire Ground (−) |
| 30 | FireWire Ground (−) |

The Apple Accessory Protocol is used for communication between the iPod® and serially connected accessories. The connection uses a standard 8N1 serial protocol operating at the standard rate of 19,200 baud, but higher rates (up to 57.600 baud) have been found to work properly. The protocol provides robust mechanisms for exchanging data with the player and controlling its operation using a request/response message protocol that permits the mode of operation of the player to be switched, permits the player to be used to record audio, controls the manner in which recorded audio is played (in a remote control mode), permits status information to be retrieved from the player, permits playlists to be controlled, and permits blocks of visual data to be displayed on designated portions of the display screen. Detailed specifications for the Apple Accessory Protocol are available from The iPodLinux Project at http://www.ipodlinux.org/Apple_Accessory_Protocol.

Depending on the functionality exposed by a given audio player's expansion dock, the auxiliary module in combination with the conventional player can perform a variety of functions in response to wireless datacasts received from a one-way wireless datacasting network, such as the Ambient Information Network, as described below. Information content, including audio, video or image files, which is stored the player's hard drive or flash memory, can be combined in controlled ways with supplemental content and metadata wirelessly datacast to the unit via the auxiliary module, and this information can be presented to the user in audible form via the connected headset seen at 105, or visually on the player's screen 100.

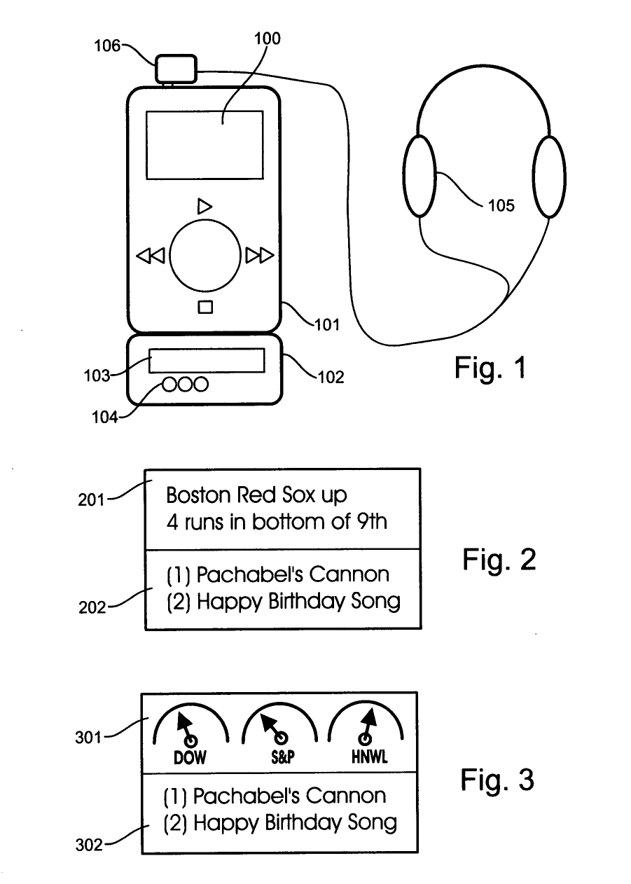

FIG. 2 shows a close-up of an illustrative screen display on an audio player equipped with the auxiliary module which receives a datacast from the wireless network. The top portion of the screen seen at 201 shows real-time wirelessly received downloaded content, such as the text of a news report, while the bottom portion of the display screen seen at 202 shows items (e.g. songs) on the audio player's playlist.

The data displayed in the illustrative example of FIG. 2 is displayed as text. As seen in FIG. 3, the wirelessly transmitted and locally stored content may be displayed on the audio player display screen in a “glanceable format” such as the three graphical “gauge hands” that provide a visual indication of three different stock prices, such as the Dow Jones Industrial Average, the S&P 500 index, and the value of a selected stock (Honeywell) in the user's portfolio. These “glanceable” representations may take many forms as described in the above-noted U.S. Application Publications 2003/0076369 and 2007/0035661 which describe devices for providing visual displays of datacast information from the Ambient Information Network. As described in those applications, the user can select the specific data to be displayed on a particular player by using a web browser interface to a website which accepts preference data from the user, of by calling a phone number, or by setting preferences using controls on the player or auxiliary module to select from a menu of available options.

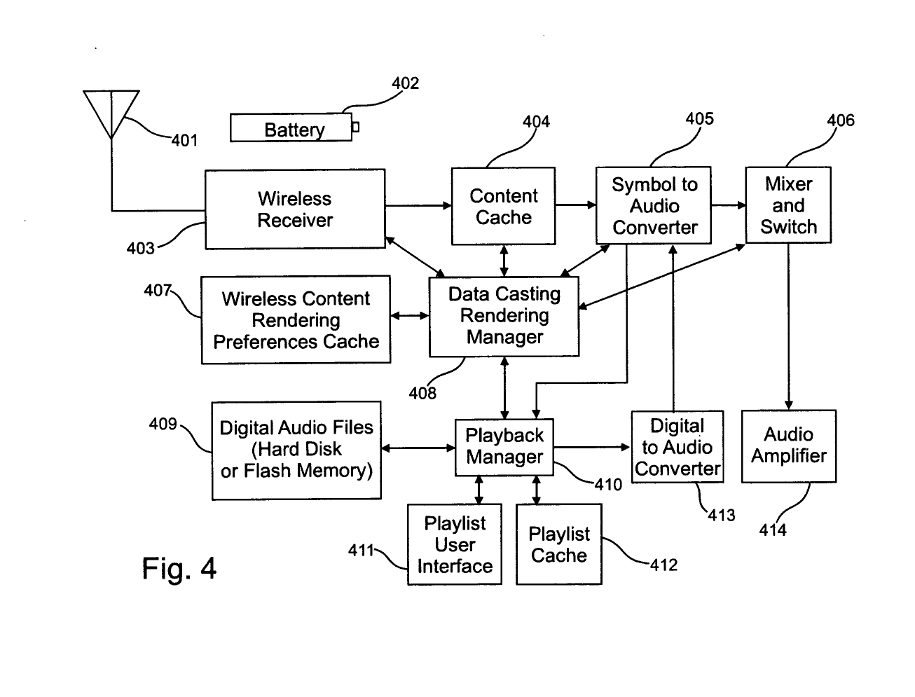

FIG. 4 shows a block diagram of a possible implementation illustrating the manner in which wirelessly downloaded and locally cached data (content, metadata, executable programs, and/or control commands) interact with various components normally found on an audio storage and playback device and the additional hardware needed to implement additional functionality. All or part of the arrangement depicted in FIG. 4 may be implemented by either a separate wireless receiver attachment (e.g. the module 102 seen in FIG. 1) interacting with a conventional music player (e.g. the player 101 seen in FIG. 1) through the expansion port, or by an audio or video player manufactured with a built-in datacasting receiver, cache and controller combined with conventional player components in a single enclosure. In the case of an external module, the external interface port provided by each player should support the following functions:
1) Ability to pause the current playlist
2) Ability to render externally generated audio through audio an output device (e.g. the headphones 105 seen in FIG. 1)
3) Ability to change the current playlist
4) Ability to render audio files stored locally on the player
5) Ability to display information on the player's screen
   Even if the external interface port only exposes a subset of these functions, many of the features described below can still be implemented. For simpler players that have an inadequate display screen, or no screen at all, a display screen may be incorporated into the auxiliary module as illustrated at 103 in FIG. 1.

The primary functional components of a combined player and datacasting receiver and data handler are shown in FIG. 4. An antenna 401 is attached to a wireless receiver 403 that demodulates the received wireless signal into a data signal, and parses that signal into data values representing content, metadata, programs, and other data that can be digitally stored and manipulated within the unit. Relevant content and data is identified by a Datacast Rendering Manager seen at 408, and designated portions of that received data are cached locally in a cache memory 404. The Datacast Rendering Manager 408 retrieves previously stored preference values from a Wireless Content Rendering Preference Cache 407 that specified which incoming content gets cached and which (if any) is ignored. The decision to cache or not cache may be further influenced by any meta-tags contained in the wireless content as parsed by the Datacasting Rendering Manager 408.

The Datacast Rendering Manager 408 exchanges control signals with a Playback Manager 410. When the Datacast Rendering Manager 408 detects a boundary between audio or video segments (e.g. songs or music videos) being played, it can command the Playback Manager 410 to pause, and switches the program source from which the content being obtained to the output of a Symbol To Audio Converter 405 which produces audio content based on the data received from wireless datacast temporarily stored in the cache memory 404. This wirelessly transmitted content is transferred from the converter 405 through a mixer/switch 406. The mixer/switch 406 selects content from the converter 405 or from the playback manager 410, and allows for some degree of overlay. For example, the wireless datacast data as rendered in audio form can begin to play before the last audio file from the player's content store 409 has completely finished playing. This is analogous to the way a radio disk jockey (DJ) often “talks over” the beginning or ending of a song being played.

The Symbol to Audio Converter 405 can render the content in a variety of ways. It can use a locally stored phoneme or audio vocabulary to form the content into a human-understandable audio stream under the control of the datacast symbols from the content cache 404. Alternatively, it can construct a verbal output using audio files stored on the audio player (e.g. in hard disk or flash memory store 409) to render the content. The playback of the datacast audio content is under complete user control. The user can customize the content and timing of this additional audio content by selectively downloading different audio files (e.g. by using an available web site), or by making recordings with a microphone attached to a remote computer which are then downloaded into the player advance for storing in the store 409 or included in the datacast stream, or the user may record audio files using a microphone (not shown) attached locally to the audio player. When rendering audio files stored on the player's flash or hard drive 409, the Symbol to Audio Converter 405 communicates with the Playback Manager 410, directing it to render a specific sequence of audio files through the digital to audio converter seen at 413.

For players capable of playing video content, the supplemental audio or video content which is derived from the datacast values received by the wireless receiver may be inserted between video segments, may be visually overlaid on the screen and displayed with the stored video content, or may be delivered the user in audio form. Supplemental video content may be produced by selecting previously stored images or video segments each of which can be uniquely identified by a datacast symbolic identifier, and the Datacasting Rendering Manger 408 and Symbol to Video Converter (not shown) can be

Once a given piece of wireless content has been rendered, it may be flagged in the Wireless Content Rendering Preferences Cache 407 as having been “played,” thereby indicating that this piece of content is eligible to be deleted to make room for new content, and also to indicate that this content should not normally be played again (unless, of course, the user has configured the unit to retain and replay designated audio segments more than once.

The audio output selected by the mixer/switch 406 is fed to an audio amplifier 414 that provides an output signal for headphones, an external speaker, or other audio rendering device (not shown). If the wireless receiver 403 and 404 is disabled or disconnected, the output from the digital to audio converter 413 is fed directly to the audio amplifier 414 without additional audio being inserted by the playback manager 408.

In addition to switching between the two audio sources, the mixer/switch 406 manager can mix the sources, or use the wirelessly downloaded and locally cached content to inject additional the audio effects; for example, by adding tones or sound effects to the audio track, changing the volume level of the audio playback, or changing the bass or treble settings/

The Playback Manager 410 includes a user interface seen at 411 and a playlist cache 412 to store various playlists each of which identifies an ordered sequence of the audio files requested by the user (or specified in a supplied playlist) and that are stored in a memory unit 409 (typically flash memory or a hard disk). The stored playlists can be created or edited by the user using a menu interface, and can be received wirelessly and transferred to the Playback Manager by the wireless receiver.

The Datacasting Rendering Manager 408 is configured via a local interface and/or via a web or telephone phone interface with the configuration parameters thereafter being wirelessly transmitted to the device from the server that accepted the parameters from the user. Configuration parameters are stored in the preference cache 407.

The datacasting receiver is preferably “always on;” that is, always provided with operating power so that it is constantly available to receive any wireless datacast that may be directed to it at a slow data rate. The unit contains a battery backup 402 to power the wireless receiver and content cache when the audio player portion is powered off. This battery can be either rechargeable or single-use. The “always-on content receiver” can be a separate component that interacts with an existing audio or video player via an expansion port, or all of the needed components can be integrated in to a single enclosure during the original manufacture of the player.

In the arrangement seen in FIG. 4, there are three separate memory storage units or “caches:” one for audio files at 409, one for playlists at 411, and one for playback manager configuration preferences at 407. Although all of these storage units could be implemented by as single storage device, such as a flash memory or hard disk on the audio playback device, this might decrease battery performance. In the arrangement seen in FIG. 4, the content cache 404 and the receiver 403 may be continuously supplied with power, while the remaining components are placed in a power conserving sleep mode when they are not being used.

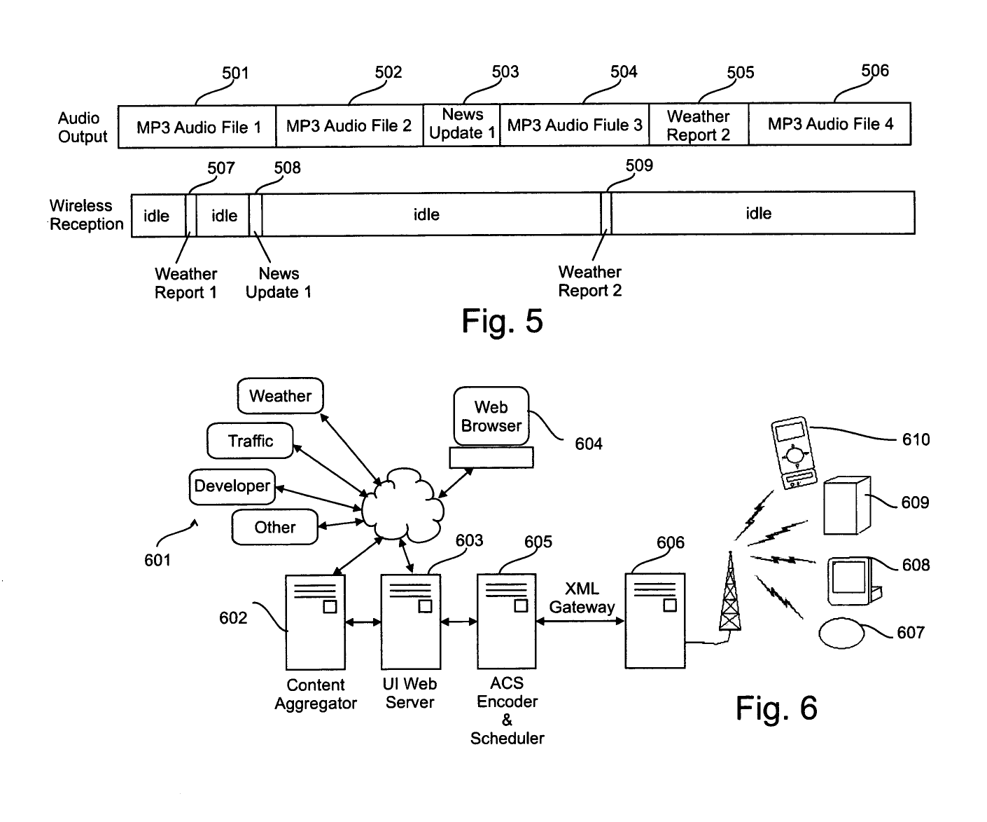

FIG. 5 shows an example timeline that illustrates a representative sequence of events during the operation of the device shown in FIG. 4. As seen in the upper horizontal time sequence bar in FIG. 5, the audio player starts by at 501 by playing the first selection in a playlist. While this audio file is playing, a wireless packet containing the weather forecast is received as indicated at 507, followed by a wireless packet indicative of the news headlines received at 508. Both these packets are stored locally in the content cache 404. Note that, in the intervals between received packets which are marked as being “idle,” the wireless network may be transmitting a substantially continuous stream of packetized data; however only selected packets are identified by the receiver as being of interest to this user, and the remainder are ignored and not stored in the content cache 404. The user has also stored preference values specifying that at least two audio files must play before the first interruption, so the news update is played immediately after the playback of the first audio file 501 is complete as seen at 503. Once the playback of the second audio file 502 is complete, the news update (previously received and cached at 508) is rendered with a female voice synthesizer at 503. Note that the duration of the playback of the synthesized voice takes more time to play than was required to receive the highly condensed news data at 508. Note also that the news update is played at 503 before weather report is played at 505 because it has been designated as having a higher priority. A third audio file is played as seen at 504 before the weather report which is followed by the playback of a fourth audio file at 506. During the playback of the audio file 504, a newer weather forecast is received at 509. In this illustration, the unit is configured such that the newer weather forecast when it arrives replaces the previous weather forecast. Thus, after playback of the third audio file 504 has completed, the most recent weather forecast received at 509 is rendered at 505.

FIG. 6 shows the commercial Ambient Information Network operated by Ambient Devices, Inc. of Cambridge, Mass., which is a preferred implementation of a wireless network capable of driving the playback devices described here. The Ambient Information Network is described in more detail in the above noted U.S. Application Publications 2003/0076369 and 2007/0035661, the disclosures of which are incorporated herein by reference. As seen in FIG. 6, various content sources 601 are aggregated by a content server 602 and held for local server storage. A web server 603 provides an interface to users who employ a web browser program executing on a computer connected to the Internet as illustrated at 604 to retrieve web page forms which are then completed by the user and submitted to the web server 603. This web user interface allows users to remotely configure various aspects of the operation of rendering devices, such as the audio player seen in FIG. 4. The configuration parameters are used by the encoder and scheduler seen 605 are transmitted as XML data that is then used to define the content of wireless packets that are transmitted by a nationwide wireless network 606. These signals are received by various devices including such as an Ambient Orb 607 (an illuminated globe that changes color to indicate changes in a specified value, such a stock index or a terror alert level), a Five Day Weather Forecaster 608 (described in U.S. Application Publication 2007/0035661), and other devices such as a Ambient Weather Beacon seen at 609, and an audio player datacast receiver seen at 610.

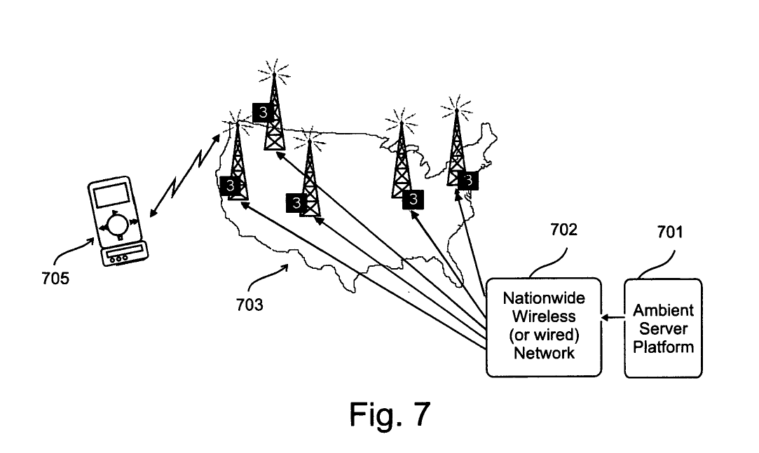

FIG. 7 illustrates the tower network utilized by the Ambient Information Network which shows five towers (in practice, more than 3,000 towers are used throughout the United States). Content from the Ambient Information Network platform seen at 701 is submitted to a gateway for a nationwide wireless network 702. This content is distributed to broadcast towers through the United States as indicated generally at 703 where the data payload is broadcast to rendering devices, such as the audio player seen at 705, each of which are located within radio range of one of these towers and receives the datacast content distributed via the network.

A notable feature of this network is its ability to send different data to the same address in different geographical portions of the country. This allows regionalized content such as local movie listings, weather forecasts, and traffic data to be sent without the device needing to know where it is located. This system works because the tower network is arranged such that aggregates of towers broadcasting identical regional information are tuned such that they do not interfere with the transmission of content from adjacent towers that broadcast different regionalized content. In other words, towers in Pennsylvania that transmit weather forecasts for Pennsylvania do not interfere with towers in New York State that transmit New York weather forecasts to the same address.

Alternatives, Modifications and Extensions

With the foregoing description of a specific illustrative embodiment as background, attention will now be turned to a discussion of the numerous alternatives, modifications and extensions that may be made to the methods and apparatus that have been described.

Visual Rendering

There are three major modes for rendering this wirelessly received and locally stored content: (1) visual rendering; (2) audio rendering; and what we will here call “sequence rendering.” By rendering we mean a method by which media is converted into a form that is physiologically compatible with human perceptual modalities; for instance, a visual display on an LCD screen or an audio presentation that is played through headphones. The various rendering modes noted below are not always exclusive; for example, text can be both visually rendered on a display or converted to speech and presented as an audio rendering.

With visual rendering, the wirelessly transmitted and locally stored content is displayed on the screen of the device. This can be the configuration screen on the audio player as illustrated at 100 in FIG. 1, or if the wireless datacasting receiver resides in an externally attached module, this display could be a separate display on this module as illustrated at 103 in FIG. 1.

Visually rendered wirelessly received content can replace or augment some or all of the information normally displayed on the portable audio player screen or can be overlaid on top of the contents of this screen. These and many other options can be configured either locally on the device, and the display may be controlled in whole or in part by meta-tag information wirelessly transmitted with the audio file information. For instance, the wireless content can specify or suggest the optimal means for rendering this content. The meta-tags can be configured via an online web interface as illustrated at 603 in FIG. 6.

The visual rendering of this content can be textural (e.g. a line of text with the words “Boston Red Sox up 4 runs in bottom of 9th”) as illustrated in FIG. 2, or glanceable such as the change in a color swatch, the percentage of a fill bar that is filled in, or the position of graphical gauge hands as illustrated at the top of FIG. 3. Glanceable renderings can include the virtual on-screen representations of the kind described in the above noted U.S. Application Publications 2003/0076369 and 2007/0035661 which describe commercially available rendering devices available from Ambient Devices, Inc. For example, a graphical rendering of the “Ambient Dashboard” on an audio playback device as illustrated in FIG. 3 conveys the same information as an actual physical Ambient Dashboard product. To the Ambient Information Network, the physical and virtual implementations have very similar requirements in terms of bandwidth and configuration. To the network and servers that power the network, the fact that one rendering device uses motors (atoms) and the other device uses pixels (bits) does not change the content or bandwidth requirements.

In many instantiations, user interface controls on the music player or on the wireless data attachment can change which portion of any cached content is displayed. Most implementations will be able to store more content than can be displayed on the screens of a music player. A local user interface allows the user to select which portion of the cached content is displayed. For example, the “fast forward” and “rewind” buttons can be used to scroll forward and backwards between different screens representing newer or older news headlines.

Audio Rendering

Audio Rendering: wirelessly received content may be converted into an audio stream delivered to the user's headphones or possibly a separate audio output. There are several ways in which to render content in an audio format, for example:
(a) Play immediately: Audio content is played in real-time as it is received, causing the audio player to stop or pause the current audio selection, depending on user preferences and/or meta-tags embedded in the content. Real-time rendering may also reduce the need for local caching if the content is disposed once it has been rendered.
(b) Play on demand: The user must interact with a user interface element to cause any stored audio content to be played. The user interface would allow the user to select which piece of wirelessly transmitted and locally cached audio content to play. For example, the user could select between, for example, a local weather report or international business news headlines. This interface would likely be similar to how users browse and select audio files.
(c) Play during audio file transitions: Wirelessly transmitted and locally cached content is automatically played between audio selections. If new wireless content has been received and cached, when one audio selection has ended the player renders cached audio content according to local configuration and/or meta-tags embedded in the audio stream. Once the wirelessly transmitted and locally cached content is done playing, the next audio file the user has requested is played by the audio player.

The user experience of this implementation is similar to listening to a live FM radio broadcast. In a typical FM radio broadcast a disk jockey (DJ) or announcer will read news headlines, weather reports, traffic updates, and local happenings after play a few songs. When the announcements are complete, the DJ plays more songs. This allows timely news and information to be mixed in with audio selections. A DJ will typically only interrupt an audio selection if the news if particularly urgent.

The difference between an FM radio broadcast is that with an audio playback device employing this invention, the user has complete control over the audio files being played and how the wirelessly received and locally cached content is rendered. Timely content is still played in the intervals between songs, but the user determines which categories of information are cached and rendered, as well as specifics about how the content is rendered.

Audio rendering of the wireless datacast may be delivered along with or “on top of” the current audio programming. This can include a “talk over,” or can be mixed in as a background noise such as a seashore noise or the sound of wind blowing. For example, the user can establish a mapping between the rising price of a given stock index, and the amount of “wind blowing” sound overlaid on the current audio track. Another variant would be to modulate some parameter of the audio file being played, such as changing the base or treble filters, or adjusting the volume or right/left balance, depending on the wirelessly received content.

Combinations of the above rendering methods are also possible. For example, an “urgency” meta-tag in the wireless content download can change the priority of the wirelessly transmitted and locally cached content. For example, extremely urgent content can interrupt the user immediately, while non-urgent content would not only wait for a song to end, but wait for the entire album to end. Another form of meta-tag could indicate temporal relevance and auto-delete if not rendered within a certain amount of time or make sure it gets rendered within a maximum time window. For example, most data about automotive traffic flow looses relevancy after approximately 30 minutes.

Sequence Rendering

“Sequence Rendering” refers to using the wirelessly transmitted signal to control the sequence in which previously stored audio files are played back to the user. An example of this would be a service that had knowledge of the audio files stored on the playback device and wirelessly downloaded a new sequence for playing back those audio files. For example, if the wirelessly transmitted and locally cached content represented lots of “bad news”, then a “happy” playlist could be transmitted to the audio player.

Optimizations

Even with advanced lossy compression, audio files tend to be at least several thousand bytes in length. Many message formats such as pagers or SMS messages have a maximum size of a few hundred bytes. Sending larger wireless payloads is possible by concatenating multiple smaller messages, but routinely sending this amount of content becomes cost-prohibitive for most consumers. Therefore a commercial implementation using current technology and cost structures will be concerned with sending frequent content updates using the smallest amount of bandwidth. While it is possible for the “wirelessly transmitted and locally cached” content to be an actual audio file, this section discusses ways to make these packets much smaller in the event that larger files prevent widespread commercial acceptance.

A straightforward method for reducing payload size is to wirelessly send text instead of audio. The transmitted text can be directly rendered on any local display screen, or a local speech synthesizer can convert it into an audio stream. For example, the sentence “Boston Red Sox up 6 runs in bottom of the 7th” is 46 characters. An audio file of an announcer reading this sentence, even after advanced lossy compression, would be at least a few thousand bytes in size.

A voice synthesizer can be further configured by local configuration and/or server generated meta-tags to render in different personalities. For example, the text can be read in a male or female voice with different tempos and/or intonations. Additional modulation parameters include pitch, tone, and mood. These modulation variables can be further influenced by meta-tags indicating the likely emotional value of the content. For example, if the home team has won, the emotion would be excited (unless the user lacked team spirit and had configured preferences accordingly).

Various technologies exist for text to speech voice synthesis. Some technologies create acoustic models of the human vocal tract and employ pronunciation guides to simulate how a human speaker would produce a given stream of text.

Other text to speech technologies use a library of pre-recorded phonemes to create speech. In general a phoneme library is only appropriate for one language. A phoneme library for English would not, in general, be appropriate for French.

Both types of text to speech require some type of front-end rules based system for translating text into phonetic units. For languages such as English with complex pronunciation rules, this can be complex. An optimization could be translating the text into phonetic units by a more powerful server computer before wireless transmission. This makes the job of audio rendering much more straightforward. It also allows for the wireless broadcast of novel words that a rules-based pronunciation guide might not understand. With appropriate human editorial oversight, proper names could always be properly pronounced. This scheme has the drawback, though, of not also being viewable as text on the LCD display screen—unless viewable text was also sent in a parallel wireless stream.

For even greater compression additional domain knowledge of the content can be utilized. For example, if a meta-tag labels a packet as “baseball”, the 14 character fragment “Boston Red Sox” could instead be a 2-byte index into a lookup table of all baseball teams. Similarly the fragment “bottom of the 7th” could be a lookup table into temporal intervals of a baseball game. In this scheme “Boston Red Sox up 6 runs in bottom of the 7th” can be unambiguously described in 3-4 bytes.

In the most highly compressed rendition, a single byte of data can be meaningful. The Ambient Information Network is optimized for the configuration and economical transmission of payloads down to a single byte in size. For example, if a user establishes a mapping between the total value of his or her stock portfolio and a color (e.g. red means lost value, yellow means stable, and green means gained value), a single byte representing this color mappings conveys a very important summary of one's personal wealth.

The key difference between “audio compression” and “symbolic audio files” is the former can arbitrarily reproduce any sound while the latter can only reproduce sounds within the designated domain. MP3 compression can compress any sound, including music, spoken word, animal noises, and sound effects such as breaking glass. A symbolic audio renderer such as a voice synthesizer is only as versatile as the sampled or synthesized tokens in its dictionary. A voice synthesize cannot, in general reproduce animal noises unless it has some algorithm to do so.

Audio Symbol Libraries

Audio symbols may be stored on a music player as compressed files. For example, existing MP3 decoder circuitry used for compressed program files can also be used to render these compressed audio symbols. This is advantageous because it does not require the addition of text to speech hardware and simple mechanism can instruct the audio player to play a series of MP3 files previously stored on the device to produce synthetic speech.

This also allows a great deal of customization. Many home PC computers have a microphone attached. By storing the audio symbols as MP3 files on the audio player, users can record their own custom library of audio symbols and download them onto their player along with regular audio selections. This allows users to have content rendered in their own voice, or in the voice of a friend. The Internet allows for these “audio symbol libraries” to be shared and/or sold. For example, celebrities could sell audio symbol libraries recorded with their voice. This would allow, for example, users to have the weather report ready by their favorite movie star.

An audio symbol library would need to adhere to some type of naming scheme so that the content renderer would be able to select the appropriate audio symbol. Users wishing to customize their audio symbol library would need to adhere to this naming convention so that the content renderer would know which file to play. Custom software running on the user's PC could manage this process and make sure the symbol library installed in the portable audio player is complete and up to date.

Finally, storing the audio symbol libraries as MP3 files makes internationalization more straightforward. Provided the new language has a similar enough grammar structure, translating the content into another language is simply a matter of recording a new set of audio in the new language. For example a Spanish language audio symbol file would use the token “nieve” instead of “snow” to report weather conditions. The logical structure of the wirelessly downloaded content is the same.

Use of an audio symbol library would require a one-time installation of the audio symbol library on the audio player. Some content can be adequately rendered with a small and fixed audio symbol library, meaning there would be no need for any maintenance. Once the audio symbol library is on the audio player cache, no additional updates are necessary. For example, audio rendering of weather content would not normally require updates. Meteorological phenomena and geographic locations are relatively fixed, and the need for new audio symbols is fairly infrequent.

Some content, though, might require periodic updates to the symbol library to add new symbols. For example, audio rendering of traffic conditions would require the addition of a new audio symbol for any new roads or bridges that have been built since the initial audio symbol library setup.

The need to update the symbol file is generally less urgent than the actual content. In the example of traffic, there are generally months of advance notice before a new road segments opens up. While traffic conditions can change minute-to-minute, road segments only change very slowly and with lots of time to prepare the audio symbol library with the new audio token.

Updates to audio symbol libraries can be accomplished by wirelessly transmitting new symbols to the device as needed. This makes the process completely transparent to the user. The device simply receives new audio symbols as necessary.

Updating the audio symbol file can also be accomplished by downloading the content over the Internet while the audio player is docked in a charging station and connected to a PC computer. This is analogous to how new content is downloaded into an audio player via a RSS feed (“podcasting”). Software installed on the user's computer would ensure any selected audio symbol libraries are fully updated so they can render real-time wireless content as it is received.

This is not as seamless as wireless transmission, but is more cost effective in a metered bandwidth environment. A DSL, cable, or T1 connection is generally faster and less expensive per byte than a long-range wireless connection. Therefore, it might be economically advantageous to download the relatively larger sized audio symbols via an Internet connection.

Content such as news headlines that have a very wide range of vocabulary could still benefit from a locally stored audio symbol library, but unless the news was restricted to a very small domain, the symbols would likely have to be the phonetic units of the target language as rendered by a text to speech converter or voice synthesizer. Users could still install alternative audio symbol libraries of different styles of phonemes so content can be rendered using different “voices”.

As an example, an “audio symbol library” for weather in the United States would likely include the following audio symbols:

TABLE 2

| Category | Example |
|---|---|
| Major cities | Boston, San Francisco, Atlanta |
| Conditions | Sunny, Cloudy, Snow, Thunder |
| Temporal | Morning, afternoon, night, followed by, before |
| modifications | |
| Digits | One . . . ten . . . hundred, minus |
| Units | Fahrenheit, Celsius, wind chill, millibars, percent, |
| | miles per hour, knots, kilometers per hour |
| Phenomena | High temperature, low temperature, humidity, |
| | windspeed, storm, high pressure, low pressure, |
| | system, stable, dew point, visibility |
| Ordinals | North, South, East, West |

Online Configuration

As previously discussed, users have the option of visiting a website or call a customer support number and optionally configure the following preference settings:
(a) What data gets transmitted by the network. For example, with the Ambient Information Network, a user can cause the network to transmit a signal corresponding to the total value of the user's stock portfolio. This is highly personal information that is not typically relevant to other users on the network. This is content that is only broadcast for a single user and would not otherwise have been broadcast except for a particular user's device.
(b) What data gets decoded by the end device. The Ambient Information Network broadcasts much more information than any single device generally decodes. A device can be programmed to only decode and cache, for example, certain stock indices while ignoring all other stock indices. A user would select, for example, they want to receive traffic reports in the morning, but not in the afternoon. The server would send a wireless message to the target device instructing the device to only decode and cache traffic conditions in the morning, and ignore traffic conditions in the afternoon. Note that this selectivity can also be controlled locally by the audio player device and/or attachment without any intervention by a centralized server. An analogy is how TV or radio is configured to listen to a single content stream by changing a tuning knob. This action changes what the TV or radio renders, but it does not change the broadcast network in any way.
(c) How the wireless content gets rendered. So far, we have described audio rendering and visual rendering, as well as variants of each. There are likely means of rendering this content.

Configuration updates performed on the server can be sent to the device in a separate wireless packet, or used to encode meta-tags describing how periodic content updates should be rendered. Users can modify how these settings are interpreted with additional configuration options local to the device.

Low Power Mode

Because a rendering device is preferably “always on” so that it can constantly listen for and cache desired data being datacast over the network, it is desirable to conserve energy. For example, Ambient Devices, Inc. makes a device called the “Five Day Weather Forecaster” which is described in the above-noted U.S. patent application Ser. No. 11/149,929 filed on Jun. 10, 2005 entitled “Methods and apparatus for displaying transmitted data.” The “Five Day Weather Forecaster” receives a wireless signal indicative of the weather forecast for the upcoming five days. This device operates continuously for six months on 2 AA batteries. About half of this electrical current powers the LCD display and driver chip, while the other half is used to power the content receiver. Therefore, without the always-on LCD display, the content receiver alone would last about a year with 2 AA batteries. This is significantly less electrical current than is consumed by an audio player, and is likely less than the self-discharge rate of the rechargeable batteries often used to power portable versions of audio players.

Given the very low power consumption of the data content receiver, the receiver may be employed in rendering devices that are always on and therefore always receiving content. Audio players are generally powered off when not in use to converse battery power. But if the content receiver remains powered, it can continue to wirelessly receive user-selected content that is stored locally on the device. When the user next activates their audio player, the most up to date content is available immediately. The user does not need to wait for communication between the device and network, or for the device to receive the next update from the network. With an always-on receiver, the device already has access to the latest content the moment it is powered. The user experiences this as zero-latency information display.

Local caching by an always-on device allows the server to only transmit new content when there has been an actual change in content. If, for example, there is no change in traffic conditions, there is no need to transmit traffic content because receivers already have the latest traffic information ready.

Data receivers that power off (e.g. Radio Display System (RDS) receivers that display the artist, album, and track title information on FM radio receivers) must wait for the next periodic broadcast before they can display updated content. This forces the data provider and/or network operator to send out data much more often than necessary in order to limit the amount of time a user must wait between powering a device and having it display content. Similarly, 2-way devices typically need time to handshake with the network and/or communicate with a content server when first powered. While this is often faster than waiting for the next periodic broadcast, it is still experienced by users as latency.

In practice, a maximum interval may be established between content updates to cover situations where:
1) The user has activated the device for the first time. For example, if a user purchases a device that caches stock market prices, and activates it for the first time on a Friday afternoon, he or she would have to wait until Monday morning before the prices changed. Many users would experience there is the device being broken. Therefore additional content updates transmitted over the weekend would allow new users to receive content in a timely manner.
2) The user is temporarily in a no-reception zone. No matter how good the wireless coverage, there are always going to be locations that do not receive signal. Therefore when the user moves back into a covered area, it would be advantageous to not make them wait too long before receiving updated content.

Adding an indicator of “stale data” and/or the time of the last successful update could help the user determine the relevancy of any cached content. Similarly a warning or other indicator could inform the user the content receiver has been in a no-coverage area and therefore might not have the latest content. A meta-tag may be transmitted to indicate the duration of time for which the content is valid. For instance, traffic content may be marked as being valid for 15 minutes. If no new traffic content arrives, the user interface could play the older data with a suitable warning that the current data might not be relevant.

Generalities

Many aspects of the embodiments described here are optimizations to increase the commercial feasibility of the playback devices in environments where bandwidth is constrained and/or not free. However, the invention can also be used to advantage in environments where bandwidth is more freely available.

It is important to emphasize the “wirelessly transmitted and locally stored content” can be an actual audio file. This audio file can be synthetically generated by the server, or can be a recorded message—for example as read by a well-known sportscaster. The present invention may be used to advantage to playback cached content that falls in the interval between one audio file and another audio file. There is no need for the wirelessly downloaded audio file to be in a symbolic or textural format.

Devices such as Video iPod® also create the opportunity for new rendering modes. Because a portable video player is designed to be viewed and heard, cached content can be visually displayed in real-time. One example would be a “text crawl” that appears overlaid on the video stream in real time. Because users are watching the device, this visual overlay may be less distracting than an audio overlay or audio insertion between media segments.

Additionally, the optimizations described in this disclosure can also be generalized to video. For example, the techniques described for using “audio symbol libraries” can be generalized to include using “video symbol libraries” of announcers being filmed reading text. Similarly synthetic audio generation can be generalized to include synthetic video generation using computer graphics routines to generate video derived from the wireless content.

The content rendering described here can be further generalized to include any human sensory modality, including smell and touch.

Device incorporating text to speech hardware can deliver feedback about local status with only changes to software. One example would be an announcer that reads song titles between audio files. Other meta-tag information associated with the MP3 could also be announced, such as billboard rankings, song length, or encoding type. Similarly, the text to speech could announce signal strength of the wireless receiver and battery life.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. A wireless data processing module for use with an audio or video player comprising, in combination,
an interface port for exchanging data and control signals between said wireless data processing module and said existing player,
a radio receiver for receiving data signals from a wireless data transmission network,
a memory for storing said data signals, and
a controller responsive to operating commands accepted from a user for controlling said player to selectively play program content segments persistently stored by said player and to render selected data signals in said memory in a form perceptible to said user

2. The wireless data processing module as set forth in claim 1 wherein said audio or video player includes a display screen and wherein said controller renders selected data signals in said memory as a visual presentation on said display screen.

3. The wireless data processing module as set forth in claim 2 wherein said visual display on said display screen includes displayed text derived from selected ones of said data signals in said memory.

4. The wireless data processing module as set forth in claim 2 wherein said visual display on said display screen includes one or more graphical symbols which are representative of the values represented by selected ones of said data signals in said memory.

5. The wireless data processing module as set forth in claim 2 further including a memory for storing visually displayable blocks of data and wherein said selected data signals in said memory identify selected ones of said blocks of data that are presented as part of said visual presentation on said display screen.

6. The wireless data processing module as set forth in claim 2 wherein said display screen is a liquid crystal display panel forming part of said audio or video player.

7. The wireless data processing module as set forth in claim 1 wherein said audio or video player includes an audio output port and wherein said controller renders selected data signals in said memory as a audio presentation delivered to said audio output port.

8. The wireless data processing module as set forth in claim 7 wherein said controller delivers said audio presentation to said audio output port in substantially real time immediately after the reception of said selected data signals by said radio receiver.

9. The wireless data processing module as set forth in claim 7 wherein said controller delivers said audio presentation to said audio output port in response to one of said operating commands accepted from said user.

10. The wireless data processing module as set forth in claim 7 wherein said controller automatically delivers said audio presentation to said audio output port between the playing of successive ones of said program content segments persistently stored by said audio player.

11. The wireless data processing module as set forth in claim 7 wherein said controller includes a mixer for combining selected portions of said program content segments with selected portions of said audio presentation for simultaneous delivery to said audio output port.

12. The wireless data processing module as set forth in claim 7 further including a speech synthesizer for rendering said selected data signals as a spoken audio presentation delivered to said audio output port.

13. The wireless data processing module as set forth in claim 12 further including a memory for storing prerecorded audio segments each of which is identified by a specific data value and wherein said speech synthesizer forms said audio presentation by combining a plurality of said prerecorded audio segments that are specified by data values contained in said data signals in said memory.

14. The wireless data processing module as set forth in claim 1 wherein said controller includes means for independently controlling the play of said program content segments and the rendering of said selected data signals in a form perceptible to said user.

15. The wireless data processing module as set forth in claim 14 wherein said controller is responsive to preference indications supplied by or on behalf of said user for selecting specific data signals in said memory for rendering in a form perceptible to said user.

16. The wireless data processing module as set forth in claim 15 wherein said preference indications are supplied by or on behalf of said user by employing a web browser or telephone interface to submit said preference indications to a remote server to control the content of said data signals transmitted to said radio receiver via wireless data transmission network.

17. The wireless data processing module as set forth in claim 1 wherein said controller alters the sequential order in which said program content segments are selectively played in response to selected ones of said data signals.

18. An interactive system for rendering previously stored program segments along with additional information simulcast to a plurality of different receiving locations via a wireless data transmission network, said system comprising, in combination:
a wireless data receiver for receiving an information bearing signal broadcast from a remotely located information source via said wireless data transmission network,
a decoder for extracting received data values from said information bearing signal,
a cache memory coupled to the output of said decoder for storing said received data values,
a memory unit for persistently storing a plurality of previously recorded program segments,
a rendering device for presenting audible or visual representations of at least selected ones of said received data values to a user,
an input device for accepting commands from a user, and
a controller coupled to said cache memory and said memory unit and responsive to said commands for selectively presenting said previously recorded program segments and audible or visual representations to said user.

19. An interactive system as set forth in claim 18 wherein said information bearing message is transmitted via said wireless data transmission network in a one-way broadcast to said wireless data receiver.

20. An interactive system as set forth in claim 19 wherein said wireless data transmission network is selected from the group comprising GSM, FLEX, reFLEX, control channel telemetry, FM or TV subcarrier, digital audio, satellite radio, WiFi, WiMax, and Cellular Digital Packet Data (CDPD) networks.

21. An interactive system as set forth in claim 19 wherein the content of said data signals transmitted to said radio receiver via wireless data transmission network is specified by preference values supplied by or on behalf of said user by employing a web browser to submit said preference values to a web server.

22. An interactive system as set forth in claim 19 wherein the content of said data signals transmitted to said radio receiver via wireless data transmission network is specified by preference values supplied by or on behalf of said user by employing a telephone interface to submit said preference values to a remotely located database.

23. An interactive system as set forth in claim 19 wherein the content of said data signals transmitted to said radio receiver via wireless data transmission network is specified by preference values supplied by said user using said input device.

24. In an audio or video player of the type including an input device for accepting input command data from a user, a program memory for storing previously recorded program segments, an audio output, and a display screen, the improvement comprising:
wireless data receiver for receiving data bearing messages transmitted via a one way wireless datacasting network,
a cache memory,
a decoder for extracting selected data values from said data bearing messages and for storing said data values in said cache memory, and
a processor coupled to said cache memory and to said player for selectively presenting a combination of said previously recorded program segments and information representing selected ones of said data values in a form perceptible to said user.

25. The improvement as set forth in claim 24 wherein said processor renders selected ones of said data values as a visual presentation on said display screen.

26. The improvement as set forth in claim 25 wherein said visual presentation on said display screen includes displayed text derived from selected ones of said data values in said cache memory.

27. The improvement as set forth in claim 24 wherein said processor further renders selected ones of said data values as an audible presentation delivered to said audio output.

28. The improvement as set forth in claim 24 further including a speech synthesizer for rendering said selected ones of said data values as a spoken audio presentation delivered to said audio output.
